(19) United States
(12) Patent Application Publication
(10) Pub. No.: US 2008/0079220 A1
(43) Pub. Date: Apr. 3, 2008

(54) ROTARY SEAL FOR DIFFUSION FURNANCE INCORPORATING NONMETALLIC SEALS

(75) Inventors: Michael Kovalerchik, Castro Valley, CA (US); Craig Collins, Santa Cruz, CA (US); Chris Ratliff, Santa Cruz, CA (US)

Correspondence Address: GIFFORD, KRASS, SPRINKLE,ANDERSON & CITKOWSKI, P.C, PO BOX 7021, TROY, MI, 48007-7021, US

(73) Assignee: Aviza Technology, Inc., Scotts Valley, CA (US)

(21) Appl. No.: 11/467,976

(22) Filed: Aug. 29, 2006

(51) Int. Cl. F16J 15/00

(52) U.S. Cl. 277/345

(57) ABSTRACT

An environmental seal incorporated into a diffusion furnace having a heated chamber including a rotatable susceptor and integrally formed shaft support. A plurality of silicon wafers are supported on an associated carrier centered upon the turntable and rotated at a selected velocity. The processing chamber is heated to a selected temperature range and, corresponding to a desired (typically subatmospheric pressure) environment established within the interior and the introduction to a desired recipe of gaseous components/dopants, facilitates a wafer material treatment within the furnace. The use of a nonmetallic environmental seal, typically in the form of a spring-loaded rotary seal or multiple O-ring arrangement, prevents the escape of heat or introduction of pressure/particle contaminants into the chamber. One or more mirror surfaces further assist in retarding heat loss.

### BACKGROUND OF THE INVENTION

1. Field of the Invention

The present invention deals generally with wafer substrate thermal processing. Specifically, the present invention discloses a nonmetallic rotary seal for use with a wafer carrying and rotatable platform associated with a heat diffusion furnace for performing any of a number of treatment operations such as chemical vapor deposition (CVD), atomic layer deposition (ALD), physical vapor deposition (PVD), rapid thermal processing (RTP), and dry plasma etching.

2. Description of the Prior Art

The prior art is well documented with varying examples of furnaces in use with the treatment of wafer substrates, such as are utilized in the semiconductor industry. In practice, any of a number of heat treatment applications, such as chemical vapor deposition (CVD), atomic layer deposition (ALD), physical vapor deposition (PVD), rapid thermal processing (RTP), and dry plasma etching, can be performed on a single wafer or batch of supported and spatially separated wafers.

In a preferred application, the wafer batch is supported upon a carrier in an incrementally spaced-apart fashion, and typically in multiple stacked fashion. Variations in processing environment are increased by the high temperatures often associated with many wafer processing procedures, usually well above 200° C. Temperature variations, combined in many instances with low interior pressures and the necessity of performed uniform within-wafer (WIW) and wafer-to-wafer (WTW) reaction processing within the furnace interior, and the requirements of maintaining an even temperature and reaction profile within the furnace typically require that a single wafer or batch be supported upon a rotatable platform and that the same be rotated at a speed anywhere up to a dozen revolutions per minute to enhance uniformity.

In practice, a single wafer or wafer batch is placed on a carrier or boat placed within the diffusion furnace. In order to retain chamber integrity and lessen contamination concerns, a chamber platform surface, carrier or boat is often formed of the same material such as quartz. A mechanism is provided for accurate temperature control. As is known in the art, maintaining effective temperature control is critically important as rates of diffusion of the various silicon dopants, deposition, etch and other reaction rates are primarily a function of temperature and which may range in use upwards of 1300° C.

Existing rotary seals associated with such processing chambers with rotatable platforms often incorporate ferromagnetic and other metallic based composition seals. Experience has determined that such metallic seals tend to emit contaminates into a chamber when a seal is heated. Given the precise compositional requirements which must be maintained in wafer processing, the introduction of contaminants such as those deriving from compromised magnetic/ferrofluidic seals can quickly compromise the processing chamber components and poison any wafer held within the processing chamber.

### SUMMARY OF THE PRESENT INVENTION

The present invention discloses an improved and nonmetallic rotary seal for use with a wafer carrying and rotatable platform associated with a heat diffusion furnace. In particular, the present invention contemplates replacing traditional metallic (e.g. ferrofluidic) seals with any of a number of typically spring-loaded and nonmetallic seals, including those constructed of fluoropolymers, to prevent both the passage of gases into or out of the furnace processing chamber. Teflon® is a registered trademark of E.I. DuPont De Nemours and Company and is representative of synthetic resinous fluoropolymers in the form of molding and extruding compositions and fabricated shapes such as sheets, rods, tubes, tapes and filaments.

A conventional wafer processing chamber typically includes a heated vessel including a rotatable susceptor, typically further provided by a quartz turntable and integrally formed shaft support. As previously described, a single wafer or batch of wafers are held within a carrier centered upon the turntable and rotated at a selected velocity. The vessel is heated to a selected temperature range and, corresponding to a desired (typically subatmospheric) environment established within the vessel interior and the introduction to a desired recipe of gaseous reagents, facilitates a given treatment chemistry occurring to a wafer substrate within the processing chamber.

Additional variants of the present invention include the substitution of one or more dynamic O-rings constructed of a durable and high temperature resistant elastomer, such as further known under the commercial names Calrez® (Lumaco) or Kalrez® (DuPont Performance Elastomers) for the spring-loaded and fluoropolymer seal. One or more mirrored surfaces may also be incorporated into the diffusion furnace construction, such as underside of the quartz turntable or associated door, as well as at a lowermost location associated with the integrally formed quartz shaft.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a partial cutaway view of a diffusion oven interior according to the present invention and illustrating the features of the integrally formed and rotatable turntable and support shaft, mirrored and heat reflective lower surface, and spring-loaded fluoropolymer seals to prevent the occurrence of volatile emissions associated with conventional ferrofluidic type seals;

FIG. 2 is a perspective view of one example of a silicon wafer diffusion furnace according to a variant of the invention;

FIG. 3 is a partial cutaway view illustrating an alternate embodiment of the invention and by which the spring-loaded Teflon® seals are substituted by one or more dynamic O-rings of a high temperature resistant elastomer, as well as illustrating another variant for incorporating a heat reflective mirrored surface to an underside of the quartz shaft; and

FIG. 4 is a partial view of a further alternate variant of a spring-loaded seal arrangement incorporated into a diffusion type furnace according to the present invention.

### DETAILED DESCRIPTION OF THE PREFERRED EMBODIMENT

The present invention has utility in the formation of a rotary seal in a wafer processing chamber. An inventive seal lacks the catastrophic failure mode associated with conventional ferrofluidic seals.

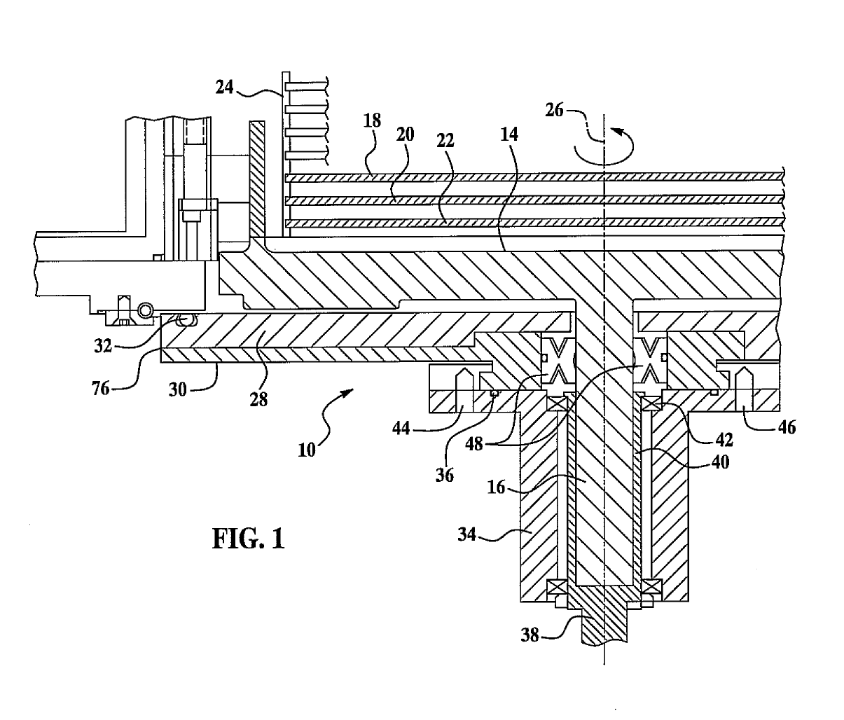

Referring now to FIG. 1, a partial cutaway view is illustrated at 10 of a diffusion furnace interior according to a variant of the present invention. As previously described, the present invention teaches the incorporation of an improved environmental seal, primarily to avoid the introduction of contaminants within the chamber interior. As also described, the environmental sealing features associated with the prior art suffer from the emission of particulate associated with thermal failure of conventional ferrofluidic (metallic) seals, as well as the escape of heat or introduction of external pressurization into the carefully created environmental conditions associated with the furnace interior.

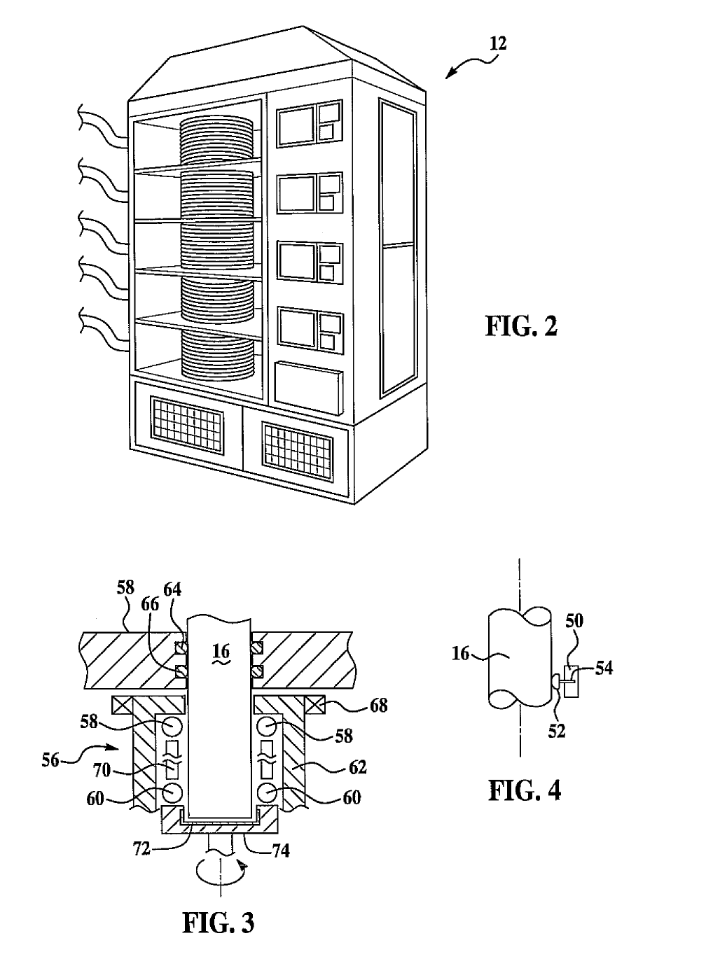

Reference is generally made in FIG. 2 at 12 of an example of a diffusion furnace according to one desired illustration. The furnace 12 is intended only to show one generally representative and nonlimiting example of a typical diffusion furnace for use in the wafer processing technology, and which is intended to provide continuous operating conditions at elevated temperatures (upwards of several hundred degrees Celsius) for such as chemical vapor deposition (CVD), atomic layer deposition (ALD), physical vapor deposition (PVD), rapid thermal processing (RTP), and dry plasma etching and the like. The representation 12 of FIG. 2 is further intended only to be representative of a desired three-dimensional enclosure environment that provides such components as controls for admitting a desired gas or vapor into the chamber concurrent with establishing a desired elevated temperature.

As will be described in further reference to FIG. 1, the essential aspects of a diffusion furnace for purposes of the present disclosure are the existence of a rotatable susceptor or turntable surface, see at 14 in FIG. 1, associated with an integrally defined and extending shaft portion 16, and upon which is supported one or more wafer substrates as depicted at 18, 20, 22, et seq. in FIG. 1. The wafers are typically supported in a closely spaced fashion upon a carrier 24, centered relative to a rotational axis 26 associated with the rotatable platform 14. It is appreciated that workpieces other than wafer substrates are processed herein and include industrial pieces subject to oxidation, nitrification, or other coating process.

It is desired to treat one or more wafers 18, 20 and 22 (ranging in multiple stacked fashion up to a hundred or more) within a desired internal environment selected from a desired, temperature, pressurization and varying chemical makeup. In order to maintain a consistent heat and chemical pattern across all of the waters, the same are made to rotate upon the platform 14 at a velocity from one or two to upwards of several to ten or more revolutions per minute, the same preventing localized heat spots or inconsistent reagent flow patterns across a wafer.

The integrally formed and rotatable susceptor 14 and integrally formed support shaft 16 are typically constructed of a heat insulating surface, which may include any of a number of different materials including quartz, silicon carbide, silicon nitride, polycrystalline silicon material, stainless steel or oxide-containing ceramic compositions. A quartz or other insulating material, such as that from which door 28 is constructed, is provided between the rotatable platform 14 and an underlying stainless steel layer 30. Optionally, a ceramic coating is applied directly onto the stainless steel.

A process chamber seal 32 is arranged at an outer circumferential location associated with the platform and incorporated into the underside positioned door 28. Additional components associated with the furnace enclosure include a housing 34 surrounding the shaft 16 and incorporating a static seal 36 in abutting fashion with a surface of the door 28 located opposite the process chamber seal 32.

Supported at a lower end of the housing 34 is an input drive shaft 38, the same including an upwardly extending sleeve 40 portion for seating and rotatably slaving the integral shaft portion 16 of the rotating susceptor 14, as well as an associated and end support bearing 42 positioned between the outer annular end of the sleeve 40 and the inner annular surface of the housing 34. A plurality of annularly positioned clamps 44 and 46 assist in securing the housing 34 to the underside positioned door 30.

Sealing the underside location of the rotating susceptor 14, from which the shaft 16 extends, is accomplished by substituting the ferrofluidic or other metallic-based seals of the prior art with, in the instance of one variant, a nonmetallic and chemically inert material in the form of a spring-loaded rotary seal 48 which is biased at an outer annular location against an inner annular location of the door 30 (typically a stainless steel material) and at an opposite and inner end biased against the outer circumference of the rotating shaft 16 prior to the same seating within the sleeve 40 of the input shaft drive.

In a preferred embodiment, the spring-loaded rotary seal 48 is constructed of synthetic resinous fluoropolymer such as polytetrafluoroethylene, perfluoro alkoxy polymer resins, fluorinated ethylene-propylene, ethylene tetrafluoroethylene, ethylene chlorotrifluoroethylene, polyvinylidene difluoride, polychlorotrifluoroethylene, fluorocarbon rubber chlorotrifluoroethylene, perfluoro elastomers (FFKM), and fluoroelastomers (FKM). An advantage of utilizing an inventive seal in place of a ferrofluidic or like metallic based seal is to prevent the drawing of metal-containing particulate into the chamber as volatile materials, such as which currently occurs with seal temperatures in excess of 200° C.

Referring to the partial view of FIG. 4, a further alternate variant of a spring-loaded seal arrangement incorporated into a processing chamber is shown according to the present invention. This includes the substation of the rotary seal 48 with a modified arrangement including a fixed annularly spaced component 50, from which a biasing component 52 projects inwardly against the exterior circumferential surface of the shaft 16 and is biased in its inwardly directed fashion by an alternately configured spring component 54. Other and potentially differently configured rotary seal designs are envisioned within the scope of the invention, each incorporating a chemically inert and heat-resistant material in the manner previously described.

Referring further to FIG. 3, a partial cutaway view is shown at 56 illustrating an alternate embodiment of the invention, and by which the spring-loaded seals of FIGS. 1 and 4 are substituted by one or more dynamic O-rings, see further at 58 and 60, interposed between upper and lower exterior circumferential locations associated with the shaft 16 and an associated inner location associated with a housing or shaft support location 62 extending downwardly from the rotating platform (not shown in this illustration). The O-rings 58 and 60 are also constructed of a chemically inert and durable temperature-resistant elastomer, such as FFKM or FKM which are known under the commercial names Calrez® or Kalrez®.

Additional features include a modified configuration of an insulating door 58, including inner static seals 64 and 66, and bearing 68 supporting the outer location of the shaft support 62. An interposed and lengthwise extending collar or support is shown in reduced fashion at 70 in FIG. 3 and is understood to spatially arrange and support the dynamic O-rings 58 and 60 at desired locations relative to the shaft 16 and relative outer annular housing/support components 62.

An additional feature of the invention, additional to the chemically inert and heat resistant elastomeric sealing components, is the incorporation of at least one heat reflective and mirrored surface for the purpose of further reducing heat loss from furnace enclosure to the outside environs. In the illustration of FIG. 3, a first selected mirrored surface is illustrated at 72 and which may be incorporated either into a fixed or rotatably associated portion of a lowermost and end positioned shaft drive support 74.

Experimentation has determined that one pathway of heat loss exists along the extending shaft 16 and the provision of a mirroring surface at the end cap location will tend to redirect and reduce thermal heat loss at this location. Referring again to FIG. 1, a further mirrored surface location is referenced at 76 and such as which may exist at the junction between the quartz (or other heat insulating) door 28 and the succeeding stainless steel 30 layer, the provision of a mirroring surface at this location further interrupting heat losses from the furnace.

Having described our invention, other and additional preferred embodiments will become apparent to those skilled in the art to which it pertains and without deviating from the scope of the appended claims.

We claim:

1. An environmental seal for use with a diffusion furnace, comprising
a three-dimensional enclosure incorporating a rotatable susceptor adapted to support at least one workpiece to be subjected to at least one condition of an elevated temperature and a reduced pressure;
said susceptor having a shaft extending from said enclosure and which is actuated to rotate said platform at a selected velocity; and
at least one chemically inert material defining a circumferentially extending and environmentally sealing component about said shaft at a temperature above 200° C.

2. The invention as described in claim 1, wherein said at least one chemically inert material is a synthetic resinous fluoropolymer in the form of an annular-shaped member biased against an exterior circumferential surface of said shaft.

3. The invention as described in claim 2, wherein said annular-shaped member is a spring-loaded rotary seal.

4. The invention as described in claim 3, wherein said spring-loaded rotary seal has a specified shape and size and is formed of a fluoropolymer or a polyamide-filled fluoropolymer material.

5. The invention as described in claim 2, wherein said annular-shaped member is at least one O-ring.

6. The invention as described in claim 5, wherein said annular-shaped member is a pair of O-rings arranged in spaced-apart fashion about said shaft, each of said pair of O-rings constructed of a durable and high temperature resistant elastomer.

7. The invention as described in claim 6, wherein each of said pair of O-rings exhibiting a specified shape and size is formed of a material selected from the group consisting of FFKM and FKM.

8. The invention as described in claim 1, further comprising at least one mirrored and heat-reflecting surface incorporated into an exterior location associated with said enclosure.

9. The invention as described in claim 8, further comprising a mirrored surface positioned underneath said rotatable platform.

10. The invention as described in claim 8, further comprising a mirrored surface positioned between said shaft and an associated input shaft drive.

11. The invention as described in claim 1, said susceptor and extending shaft being integrally constructed and formed from a material selected from the group consisting of: quartz, silicon carbide, silicon nitride, polycrystalline silicon material, stainless steel and oxide-containing ceramic.

12. The invention as described in claim 1, further comprising a process chamber seal arranged at an outer circumferential location associated with said susceptor and incorporated into an underside positioned door.

13. The invention as described in claim 12, said door exhibiting a specified shape and size and including at least one layer of a material selected from the group consisting of: quartz and stainless steel.

14. The invention as described in claim 12, further comprising a static seal incorporated into a housing surrounding said shaft and in abutting fashion with a surface of said door opposite said process chamber seal.

15. The invention as described in claim 3, said rotatable susceptor and shaft further comprising a heat insulating material, a steel door positioned underneath said susceptor and including an inner annular location against which is biased said environmentally sealing component.

16. The invention as described in claim 15, wherein said susceptor and shaft are both formed from a single material selected from the group consisting of: quartz, silicon carbide, silicon nitride, polycrystalline silicon, stainless steel and oxide-containing ceramic material, a heat insulating door being interposed between said platform and said steel door.

17. The invention as described in claim 14, further comprising a plurality of annularly positioned clamps for securing said housing to said under positioned door.

18. A diffusion furnace for thermally treating at least one wafer, comprising:
a three-dimensional enclosure incorporating a rotatable susceptor adapted to support the at least one wafer and subjected to at least one condition of an elevated temperature and a reduced internal pressure condition associated with a treatment process performed upon the at least one wafer;
a shaft extending from an underside of said susceptor and which is actuated to rotate said susceptor at a selected velocity; and
a chemically inert and nonmetallic material formed as at least one circumferentially extending and environmental seal arranged about an extending location of said shaft at a temperature above 200° C.;
said environmental seal preventing the escape of heat as well as the introduction of external pressure and chemical contaminants into said enclosure.

19. The furnace as described in claim 18, said at least one chemically inert material is a synthetic resinous fluoropolymer in the form of an annular-shaped member biased against an exterior circumferential surface of said shaft.

20. The furnace as described in claim 19, said annular-shaped member is a spring-loaded rotary seal.

21. The furnace as described in claim 19, wherein said annular-shaped member is at least one O-ring.

22. The furnace as described in claim 21, wherein said annular-shaped member is a pair of O-rings arranged in spaced-apart fashion about said shaft, each of said pair of O-rings constructed of a durable and high temperature resistant elastomer.

23. The furnace as described in claim 18, further comprising at least one mirrored and heat-reflecting surface incorporated into an exterior location associated with said enclosure.

24. The furnace as described in claim 23, further comprising a mirrored surface positioned underneath said rotatable platform.

25. The furnace as described in claim 23, further comprising a mirrored surface positioned between said shaft and an associated input shaft drive.

26. The furnace as described in claim 18, wherein said rotatable susceptor and shaft further comprise a heat insulating material, a steel door positioned underneath said susceptor and including an inner annular location against which is biased said environmentally sealing component.

27. The invention as described in claim 26, wherein said susceptor and shaft are both formed from a single material selected from the group consisting of: quartz, silicon carbide, silicon nitride, polycrystalline silicon, stainless steel and oxide-containing ceramic, a heat insulating door being interposed between said platform and said steel door.
